(19) United States
(12) Patent Application Publication
(10) Pub. No.: US 2022/0203672 A1
(43) Pub. Date: Jun. 30, 2022

(54) ROLLER CORE AND APPLICATOR ROLLER WITH INTERCHANGEABLE SLEEVE

(71) Applicant: Hannecard NV, Ronse (BE)

(72) Inventors: Mohamed-Ghaleb GRIOUI, Villeneuve d'Ascq (FR); Gunthram CORNELIS, Marke (BE); Sammy LASSEEL, Smetlede (BE); Dirk VIDTS, Ronse (BE)

(73) Assignee: Hannecard NV, Ronse (BE)

(21) Appl. No.: 17/610,797

(22) PCT Filed: May 15, 2020
(86) PCT No.: PCT/IB2020/054607

§ 371 Date: Nov. 12, 2021

(30) Foreign Application Priority Data
May 15, 2019 (BE) 2019/5319

(51) Int. Cl. B41F 31/26; B41F 27/10

(52) U.S. Cl. CPC B41F 31/26; B41P 2227/20; B41F 27/105

(57) ABSTRACT

In a first aspect, the invention relates to a roller core (2) with a tubular supporting wall (4) which extends conically widening (19). The roller core is adapted to receive an interchangeable roller sleeve (3) that can be stretched around it under air pressure. In particular, the roller core comprises an internal air distribution chamber (17) which is limited annularly by an internal surface of the supporting wall, and which is limited via an internal wall portion (27, 27′) to a smaller partial volume of the internal roller volume. In further aspects, the invention relates to an applicator roller (1), a method for mounting and dismounting roller sleeves, and a method for manufacturing roller cores.

### TECHNICAL FIELD

The invention relates to applicator rollers for lacquer applications, with a conical roller core and with an interchangeable roller sleeve.

The invention further relates to the manufacture of such rollers, and to the industrial use of these rollers for lacquer applications, for example for applying varnishes on metal plates, and optionally also on wooden plates.

### PRIOR ART

As such, applicator rollers with interchangeable roller sleeves are known from the prior art. Both cylindrical and conical roller cores and roller sleeves are known.

NL 7 707 402 and U.S. Pat. No. 4,144,812 (Strachan & Henshaw), for example, describe a printing roller with a roller core and a detachable printing sleeve, for use in rotogravure. The roller core, on the one hand, has a conical outer surface. This provides openings that serve as outlets for compressed air. The printing sleeve, on the other hand, has an inner surface which is also conical in shape and which fits snugly with the outer surface of the roller core.

This snug fit is caused by a preliminary tensioning of the printing sleeve relative to the roller core. In the relaxed state, the loose printing sleeve can therefore only be slid partially over the roller core, while it does cover the said openings. When compressed air is forced through the openings from the roller volume, the printing sleeve will expand radially. An air layer now allows the expanded printing sleeve to slide completely over the roller core. Then, when the pressure is lowered again, the roller sleeve shrinks, and tightly fixes to the roller core. The roller sleeve can only be removed when the air pressure is increased again.

Both NL 7 707 402 and U.S. Pat. No. 4,144,812 provide an internal air distribution block with radial ports to direct compressed air from a central air duct to the openings. However, the air distribution block is heavy, and it contributes significantly to the inertia of the roller. The production cost of this is also high.

DE 103 03 386 (Böttcher) further describes an applicator roller for applying varnishes to metal plates. It comprises a hollow roller core and a roller sleeve, both cylindrical in shape. With such a cylindrical design, it is necessary to provide additional air outlets near the end of the roller core. Only from this end can the loose roller sleeve be brought over the roller core. In addition, the inventors determined that the snug fit in cylindrical roller cores and sleeves is inadequate for the intended applications.

Furthermore, DE 198 46 677 (Windmöller & Hölscher) describes yet another cylindrical roller core. Internal tubing provides direct air conduction to openings through the supporting wall. However, it is very laborious to apply such internal tubing.

Some important features of applicator rollers with interchangeable roller sleeves are their simple but robust design, their durability, the clamping of the roller sleeve on the roller core, the production cost, the efficiency of the production process and the ease of use. Furthermore, the total mass and the moment of inertia are preferably as small as possible. After all, these are parts that must be able to rotate at a high frequency. As far as durability is concerned, it is also important that the roller core does not wear or tarnish only a limited amount. Among other things, no varnish must be able to penetrate between the roller core and the roller sleeve. Preferably, the roller sleeves can also be mounted and dismounted very smoothly, and preferably the air inlet is easily accessible.

In addition, the known designs do not sufficiently take into account mechanical strength and safety, in view of the greatly increased air pressure during mounting and dismounting of the roller sleeves.

The present invention seeks to find an optimal compromise between these sometimes-contrasting design criteria.

### SUMMARY OF THE INVENTION

In a first aspect, the invention relates to a conical roller core according to claim 1. As an important advantage, the volume of the air distribution chamber is limited, via an internal wall portion that is provided in the roller volume. As a result, only a limited volume is placed under air pressure during use (e.g. for mounting/dismounting roller sleeves). So only a smaller pressure energy builds up. This has important safety advantages. There are also considerations regarding the total mass and the moment of inertia of the roller core. In particular, since the air distribution chamber extends annularly along the supporting wall, the moment of inertia can be reduced.

NL 7 707 402 and U.S. Pat. No. 4,144,812 do not provide an air distribution chamber which is annularly bounded by the supporting wall itself. Instead, a combination of radial air distribution channels is provided in an air distribution block. These channels are only connected to the supporting wall at the level of the openings. The production process is more cumbersome, and the moment of inertia of the roll core is higher. Finally, NL 7 707 402 and U.S. Pat. No. 4,144,812 do not provide an internal wall portion, inside the roll volume.

DE 103 03 386 is further away from the invention, since the roller core is not conical but cylindrical. Such applicator rollers are usually not suitable for the same applications as the present invention, because cylindrical roller cores allow only a lower preliminary tension in the printing sleeve. In the relaxed state, the (cylindrical) roller sleeve can only be slid a little bit over the end of the roller core. A first set of air vents is provided there. These are provided beyond the end flanges. They connect to an annular air distribution chamber located outside the internal roller volume. The moment of inertia will therefore be greater than with alternative cylindrical designs, with air distribution channels concealed in the end flanges themselves. Finally, DE 103 03 386 does not provide an air distribution chamber which is limited to a smaller partial volume of the internal roller volume.

DE 198 46 677 describes another cylindrical roller core and is therefore also further away from the invention. A first, preferred embodiment is provided with internal tubing. A second embodiment, which is disadvantageous according to DE 198 46 677, provides an annular internal wall portion.

In a further preferred embodiment (claim 4), the wall portion comprises an annular or disc-shaped, transverse intermediate flange. This intermediate flange defines the air distribution chamber. Since compressed air in the air distribution chamber will exert an outward pressure on the supporting wall, it is advantageous that the transverse intermediate flange acts as reinforcement there.

In a further preferred embodiment (claim 5), the air distribution chamber is enclosed between two transverse intermediate flanges. The volume of the air distribution chamber can thus be severely limited, the intermediate flanges additionally providing firmness to the supporting wall in an environment of the air distribution chamber.

They are preferably welded to the supporting wall. They are further preferably welded single-sidedly from the nearest end (claim 9). The latter provides an important production advantage.

The invention further provides an applicator roller (second aspect), a method according to claim 13, for mounting and dismounting roller sleeves (third aspect), and a method according to claim 15, for manufacturing a roller core (fourth aspect).

### BRIEF DESCRIPTION OF THE DRAWINGS

FIGS. 1A-B show a simplified view and a simplified longitudinal section of a roller core according to a preferred embodiment of the invention.

FIGS. 2A-C show roller cores according to a number of alternative embodiments. The air distribution chamber is always located within the internal roller volume.

FIGS. 3A-B schematically illustrate the mounting of a loose roller sleeve over a roller core, according to a possible embodiment.

FIGS. 4A-D finally, schematically show the manufacture of a roller core according to a possible embodiment of the invention.

### DETAILED DESCRIPTION

The invention relates to a roller core, an applicator roller, a method for mounting and dismounting interchangeable roller sleeves, and a method for manufacturing roller cores.

Unless otherwise defined, all terms used in the description of the invention, including technical and scientific terms, have the meaning as commonly understood by a person skilled in the art to which the invention pertains. For a better understanding of the description of the invention, the following terms are explained explicitly.

In this document, ‘a’ and ‘the’ refer to both the singular and the plural, unless the context presupposes otherwise. For example, ‘a segment’ means one or more segments.

When the term ‘around’ or ‘about’ is used in this document with a measurable quantity, a parameter, a duration or moment, and the like, then variations are meant of approx. 20% or less, preferably approx. 10% or less, more preferably approx. 5% or less, even more preferably approx. 1% or less, and even more preferably approx. 0.1% or less than and of the quoted value, insofar as such variations are applicable in the described invention. However, it must be understood that the value of a quantity used where the term ‘about’ or ‘around’ is used, is itself specifically disclosed.

The terms ‘comprise’, ‘comprising’, ‘consist of’, ‘consisting of’, ‘provided with’, ‘have’, ‘having’, ‘include’, ‘including’, ‘contain’, ‘containing’ are synonyms and are inclusive or open terms that indicate the presence of what follows, and which do not exclude or prevent the presence of other components, characteristics, elements, members, steps, as known from or disclosed in the prior art.

Quoting numerical intervals by endpoints includes all integers, fractions and/or real numbers between the endpoints, these endpoints included.

In a first aspect, the invention relates to a roller core comprising a tubular supporting wall with an outer surface extending conically widening, from a narrower end to a wider end, which roller core is provided at both ends with a transverse end flange for bearing mounting via a shaft or journal, which roller core further provides an air inlet adapted for supplying compressed air to an internal air distribution chamber communicating with two or more outward air outlets through the supporting wall, and which roller core is thereby adapted to receive an interchangeable roller sleeve that can be stretched under air pressure around the supporting wall,
the air distribution chamber being located within an internal roller volume extending within the supporting wall and between the end flanges, and
the air distribution chamber being bounded annularly by the supporting wall at least at the level of the air outlets.

In particular, the roller core comprises at least one internal wall portion, which wall portion is positioned in the internal roller volume, and which wall portion further limits the air distribution chamber to a smaller, airtight sealed partial volume of the internal roller volume.

Together with a matching roller sleeve, such a roller core can be combined into an applicator roller. Preferably, this applicator roller is specially adapted for industrial coating of flat and/or curved surfaces. A possible application is the varnishing of metal tin material in the metal packaging industry. In such applications, high pressure is often applied to the applicator roller. Preferably, the roller core can therefore withstand relatively high line loads (e.g. 30 kg/cm or more). However, the invention is not limited to this.

A number of possible embodiments are shown in more detail in the figures and described in more detail in the description of the figures.

In any case, the first important feature is that the roller core does not provide a heavy internal block—unlike NL 7 707 402—to form separate air channels that conduct compressed air up to the air outlets. This saves on total mass and moment of inertia. Rather, the roller core forms an air distribution chamber which is bounded by the supporting wall itself. The air distribution chamber therefore automatically connects to all air outlets grouped there in an annular fashion. In general, the moment of inertia of a design can be limited by avoiding mass at a greater distance from a central axis of rotation in that object. It is therefore advantageous for the roller core that the structure of the supporting wall itself is used to delimit the air distribution chamber in an annular manner, at the level of the air outlets. The compressed air introduced can then, for example, spread annularly along the inner surface of the supporting wall. No additional structure is provided to guide air up to the air outlets. Preferably, the air outlets start directly from the air distribution chamber, through the tubular supporting wall.

Secondly, applicator rollers for industrial lacquering applications are usually a lot larger than applicator rollers for use in rotogravure flexo printing. In particular, the internal roller volume is therefore larger. When such a complete roller volume is brought under air pressure—as is the case with DE 103 03 386, a large pressure energy will build up therein. This can lead to dangerous situations. It is generally recognised in pneumatic technology that special safety measures must be taken at a maximum pressure energy of 200 bar·L or higher. On the other hand, a maximum pressure energy of 50 bar·L or lower can be considered harmless. See, for example, the European Pressure Equipment Directive (2014/68/EU). In any case, it is advantageous that the volume of the air distribution chamber is limited via one or more internal wall portions. In addition, the air distribution chamber only occupies a smaller partial volume that can come under air pressure. The total pressure energy built up is lower. 1 bar is 10⁵ Pascal.

The ‘(internal) roller volume’, as mentioned herein, refers to the reference volume that extends within the tubular supporting wall and between the end flanges. Only a smaller part of the roller volume is occupied by the air distribution chamber. Preferably, the roller volume is divided by means of at least one internal wall portion into the air distribution chamber and at least one further chamber.

Throughout this document there is also mention of ‘air outlets’, ‘compressed air’ and ‘air pressure’. Naturally, the invention is not limited to the use of one specific type of gas or gas mixture. Preferably, the air outlets extend radially through the tubular supporting wall at a specified distance from the narrower end. Preferably, this distance is at least 20% and at most 80% of the total length of the roller core, more preferably more than 20%, more preferably less than 80%, more preferably less than 70%, more preferably less than 60%, for example about 30%, about 40% or about 50% of the total length. The diameter of the air outlets is preferably between 0.5 and 5.0 mm. The number of air outlets is preferably between two and twelve. Preferably, these air outlets are uniformly distributed around the circumference. According to a non-exhaustive example, these are six air outlets which are grouped in an annular fashion and which are distributed uniformly over the circumference. The air outlets extend radially through the supporting wall.

Above, it is further specified that the roller core has a transverse end flange at both ends, for bearing mounting via a shaft or journal. It may be a shaft part (e.g. a journal) that is attached to such an end flange (e.g. by welding or screwing), or that is formed in one piece together with the end flange. In the latter case, this is referred to as, for example, a monoblock end flange+journal. However, the invention is not limited to any of these.

According to a further or alternative embodiment, the conicity of the outer surface of the supporting wall is between 0.20 mm/m and 0.50 mm/m. The ‘conicity’ refers to the diameter deviation of the outer surface of the supporting wall, over a certain length of the supporting wall. More preferably, the conicity is between 0.20 mm/m and 0.35 mm/m. For example, the conicity is about 0.25 mm/m, about 0.30 mm/m or about 0.35 mm/m.

According to a further or alternative embodiment, the diameter of the roller core is between 150 mm and 450 mm. The length is preferably between 1000 mm and 4000 mm.

The roller core is preferably made of metal, for example aluminium or steel. The roller core preferably further comprises aluminium, in view of the lower density of this material.

The roller sleeve, on the other hand, is preferably made in two layers. The roller sleeve therein comprises a roller sleeve carrier which is provided on the outside with a roller sleeve covering. For example, the roller sleeve carrier comprises a fibre-reinforced plastic. A suitable fibre material comprises glass fibre, aramid fibre and/or carbon fibre. A suitable plastic is based on a vinyl ester resin, a polyester resin or an epoxy resin. The roller sleeve covering may comprise a polyurethane, an isoprene isobutylene copolymer, a nitrile butadiene rubber, a chloroprene, an EPDM, a chlorosulfone rubber, a polyester polymer, silicone, a fluorocarbon elastomer or a rubber. Preferably, the roller sleeve covering comprises a polyurethane. Such roller sleeves are known to those skilled in the art.

According to a possible embodiment, the roller sleeve has a thickness between 1 mm and 5 mm. The thickness of the roller sleeve is preferably more than 1 mm, more preferably more than 2 mm. The thickness of the roller sleeve is preferably less than 5 mm, more preferably less than 4 mm. The thickness of the roller sleeve is preferably between 2 mm and 4 mm.

Optionally, the roller core provides an annular end stop for roller sleeves at one of either end. The end stop optionally provides for this purpose a transversely stepped, annular outer surface against which a flat end edge of the roller sleeve can abut. As an alternative, the end stop provides for this purpose an obliquely stepped, annular outer surface against which a chamfered end edge of the roller sleeve can abut. With such a design, the roller sleeve and roller core are matched to one another.

In a further or alternative embodiment, the air distribution chamber is annular or cylindrical. Both allow a circular distribution of compressed air over the air outlets along an inner side of the supporting wall. An annular chamber leaves the central axis of the roller core free. With the necessary adjustments, such a design can be compatible with both a through-shaft and with two separate shaft journals.

In a further or alternative embodiment, the air distribution chamber is limited to a partial volume in which at a pressure of 7 bar only a pressure energy of at most 200 bar·L can develop, preferably at most 50 bar·L. The pressure energy can therein be considered harmless.

Firstly, the invention is not limited to a certain value for the air pressure. Preferably, however, the air pressure during use (i.e. when mounting and/or dismounting interchangeable roller sleeves) is between 3 bar and 12 bar. More preferably, the air pressure is around 6-7 bar. For compressed air, 6-7 bar air pressure is a common value.

According to a possible embodiment, the internal roller volume is at least 30 L. If the full roller volume were to serve as an air distribution chamber, a pressure energy of 210 bar·L would build up therein at 7 bars of compressed air. Such a pressure energy can be dangerous. Special provisions must therefore be made. For example, the design must be reinforced to be able to withstand these pressures. The present invention provides an opportunity to advantageously limit the air distribution chamber to a smaller partial volume, for example about 25 L or less. At a common pressure of about 7 bar, only a pressure energy of 175 bar·L will build up herein, so less than 200 bar·L.

In a further or alternative embodiment, said internal wall portion comprises an annular or disc-shaped transverse intermediate flange. This intermediate flange defines the air distribution chamber. Since compressed air in the air distribution chamber will exert an outward pressure on the supporting wall, it is advantageous that the transverse intermediate flange acts as reinforcement there.

In a further or alternative embodiment, the air distribution chamber is enclosed between two transverse intermediate flanges. Such intermediate flanges can be positioned anywhere—preferably at 20-80% of the total roller length, measured from the narrower end. This does not affect the volume of the air distribution chamber itself.

In a further or alternative embodiment, at least one of the intermediate flanges comprises a spacer. This is advantageous during production, since the second intermediate flange can be arranged against the first (e.g. already attached) intermediate flange. Thus, in one possible embodiment, these are two separate intermediate flanges, which are arranged close to or against each other, and which are thus attached, within the supporting wall. The air distribution chamber is enclosed between them. Alternatively, it is a first intermediate flange, a spacer and a second intermediate flange which are formed in one piece (i.e. ‘monoblock’). This whole can then also be fixed within the supporting wall, for example via welded joints and/or via thermal clamping. Firstly, the invention is not limited to any of these attachment methods.

Preferably, the air distribution chamber is enclosed between a first and a second transverse intermediate flange separated by a spacer.

In a further or alternative embodiment, the spacer is provided centrally, the air distribution chamber extending annularly around the spacer. The air distribution chamber thus extends annularly, between the spacer and the inner surface of the supporting wall. Preferably, the annular air distribution chamber in cross section (i.e. transverse to a section of the ring shape) is larger than the cross section of the individual air outlets. This ensures a sufficiently even distribution of the air.

In a further or alternative embodiment, said intermediate flange or intermediate flanges are welded to the supporting wall. As an advantage, a welded connection always results in a gastight connection between the connected parts. However, the invention is not limited to welded joints. Alternatively, the intermediate flange or intermediate flanges are clamped (and preferably gastight) within the supporting wall, e.g. via thermal clamping after heating the supporting wall. Firstly, the invention is not limited to any of these.

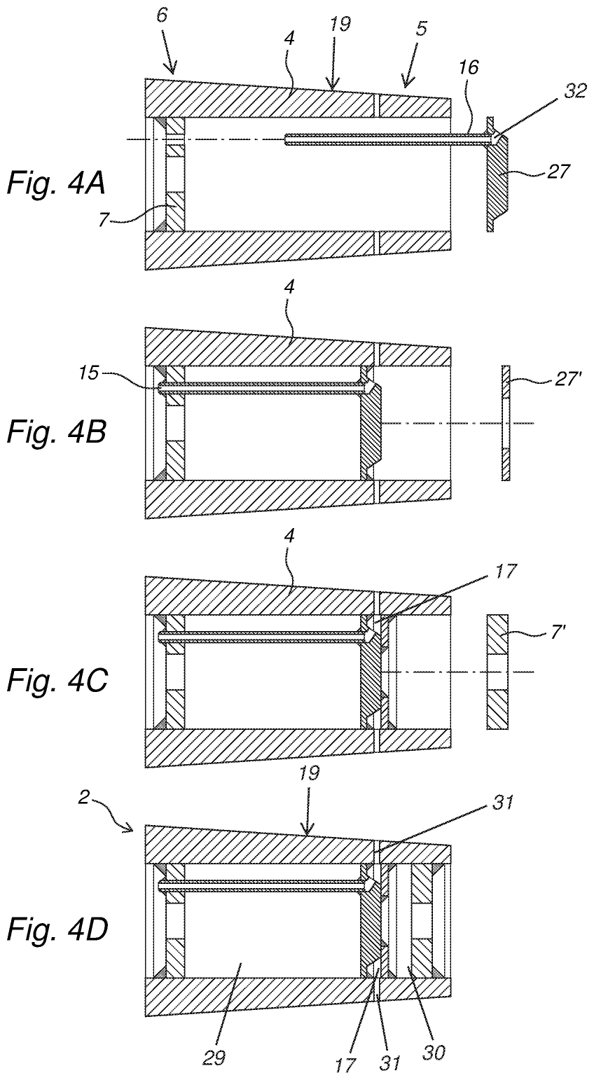

In a further or alternative embodiment, said intermediate flange or intermediate flanges are only welded single-sidedly. For example, this concerns two separate intermediate flanges positioned closer to one end and welded sequentially (and only single-sidedly) from this nearest end. See also the non-limiting embodiment of FIG. 4A-D. A single-sided weld is sufficiently strong for this application. In addition, it is advantageous to only weld the intermediate flange from the best accessible side. Preferably, the intermediate flange is provided at least 5% closer to one end than to the other end, measured relative to the total length of the roller core.

In a further or alternative embodiment, the air inlet is positioned non-centrally at one of the two end flanges. Optionally, such a non-central design is balanced by placing balancing weights. With a non-central placement of the air intake, the air inlet (and the further air distribution system) is essentially separate from the bearing. This has advantages during production, as described in the figures. In addition, a non-centrally positioned air inlet is still easily accessible. An air inlet passing through a shaft or journal, on the other hand, can weaken this shaft or journal.

According to an alternative embodiment, however, the air inlet is centrally positioned. The air inlet therein runs centrally through a shaft or journal, into the air distribution chamber.

Optionally, the roller core is further equipped with internal tubing to direct compressed air from the (centrally or non-centrally positioned) air inlet to the air distribution chamber.

In a second aspect, the invention further provides an applicator roller comprising a roller core and a roller sleeve. In particular, the roller core is in accordance with what has been described above. The same features and advantages can thus be reiterated in this regard.

In a third aspect, the invention provides a further method for mounting a roller sleeve, over a roller core, and/or for dismounting a roller sleeve, from a roller core, wherein the roller core is in accordance with what has been described above. The method comprises the steps of: (i) introducing compressed air, from the air inlet to the air distribution chamber, and (ii) sliding the roller sleeve over the roller core, under air pressure from air outlets. Preferably, the compressed air introduced can spread at least over the air distribution chamber, along an inner side of the supporting wall.

In a further or alternative embodiment, a pressure energy of at most 200 bar·L, preferably at most 50 bar·L., develops in the air distribution chamber. This has safety advantages. In the most preferred embodiment, the partial volume occupied by the air distribution chamber (and possibly internal tubing) is so small that only negligible pressure energy can build up therein, for example a maximum of 5 bar·L at 6-7 bar air pressure.

In a fourth aspect, the invention provides a further method for manufacturing the above-described roller core. The same features and advantages can be reiterated in this regard. The method comprises welding at least one internal wall portion to the supporting wall and/or to at least one of the two end flanges. In a possible embodiment, the internal wall portion comprises at least one transverse intermediate flange (annular or disc-shaped) which is welded single-sidedly to the supporting wall, from the nearest end.

In what follows, the invention is described by way of non-limiting examples and figures illustrating the invention, and which are not intended to and should not be interpreted as limiting the scope of the invention.

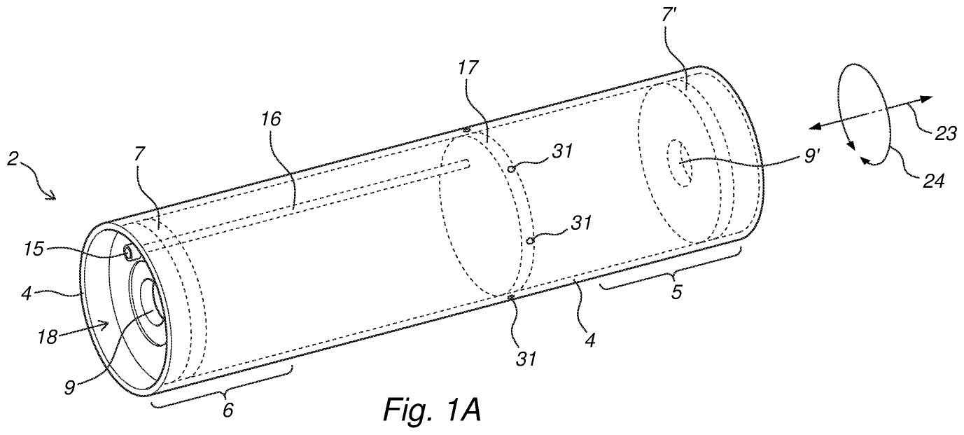

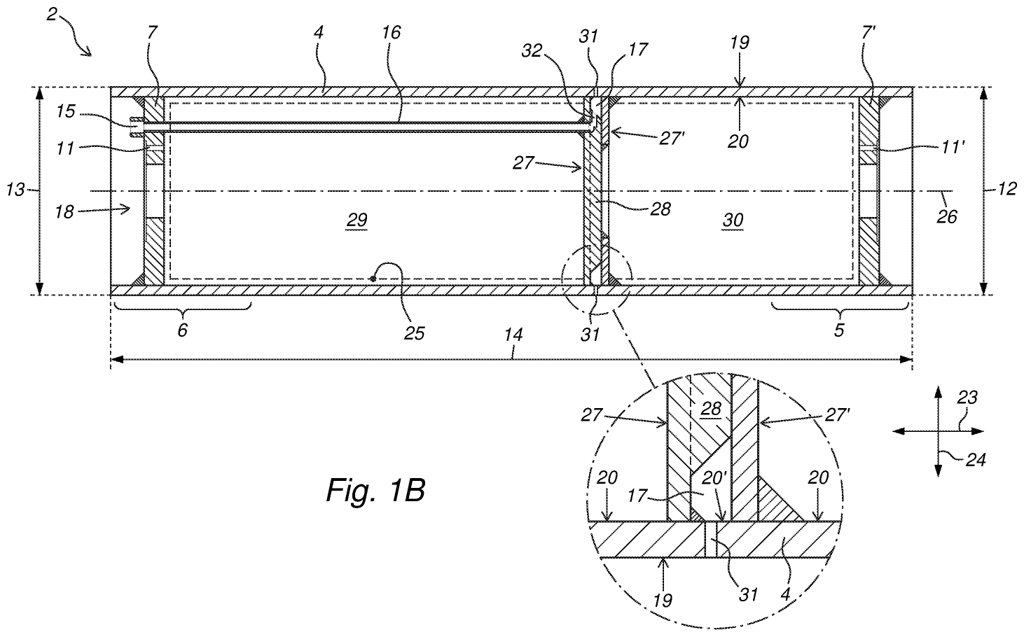

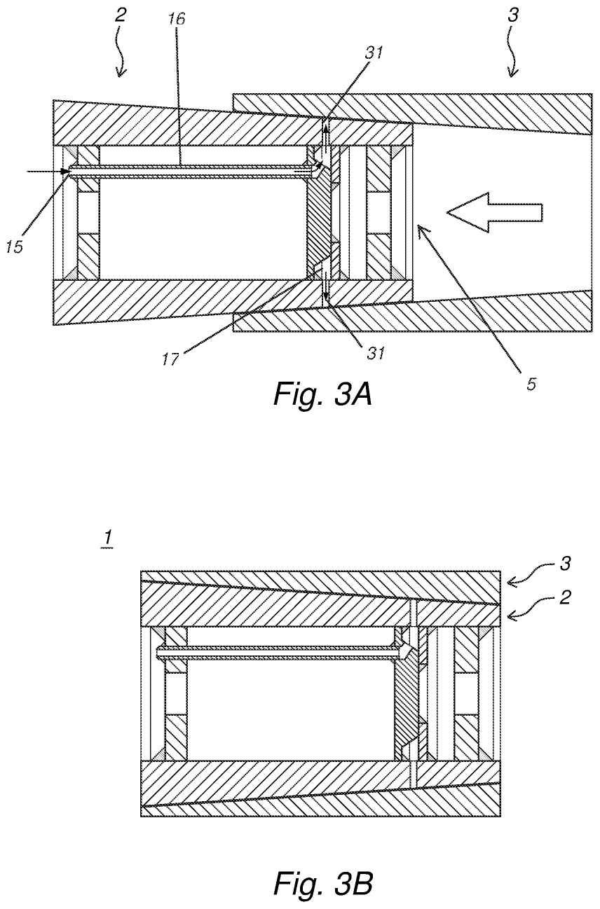

FIGS. 1A-B show a simplified view and a simplified longitudinal section of a roller core 2 according to a preferred embodiment of the invention. The roller core 2 comprises a tubular supporting wall 4 with an outer surface 19 which extends conically widening between a narrower end 5 and a wider end 6. At the narrower end 5 the supporting wall 4 has a smaller diameter 12; at the wider end 6 the supporting wall 4 has a larger diameter 13 (both measured from the end side). The outer surface 19 extends conically therebetween. The conicity of the outer surface 19 is expressed as a diameter deviation per meter of roller length and is preferably between 0.20 and 0.50 mm per meter. Such (small) conicities cannot be deduced from FIG. 1A-B with the naked eye. Notwithstanding, the these conicities are strongly exaggerated in FIG. 3-5.

At each end 5, 6 the roller core 2 is still equipped with an end flange 7, 7′. These are each provided with shaft holes 9, 9′ for attaching two separate axle journals 8, 8′ (not shown). Both a permanent attachment (e.g. via a welded joint) and a non-permanent attachment (e.g. via a screwed joint of a shaft flange 10 in the fixing holes 11—see FIG. 1B) are possible. Another possibility is that such journals 8, 8′ are formed integrally with the respective end flanges 7, 7′ (also referred to as ‘monoblock’). Alternatively, a single through-shaft 8 can also be applied. However, the design of the roller core 2 must then be compatible with a shaft that runs centrally through the full roller volume 25. The invention is not limited to any of these.

The roller core 2 is further provided with another air inlet 15 for the input of compressed air. The air inlet 15 is positioned non-centrally at an end flange 7, next to the shaft hole 9. With such a separate air inlet 15 (i.e., not integrated in a shaft or journal 8), the execution of the journal 8 and bearings is separate from the air inlet 15. It is therefore possible to produce the air inlet 15 (and possibly the complete air distribution system) of two roller cores 2 with a different type of bearing, largely in parallel, via the same or similar production steps. This contributes to the efficiency of production. As can also be seen in FIG. 1A-B, the end flanges 7, 7′ are provided at a certain distance from the end sides. The air inlet 15 is protected within a final volume 18 that arises thereby.

Compressed air can now be guided from the non-central air inlet 15 into an annular air distribution chamber 17. This air distribution chamber 17 covers only a smaller partial volume, located within the internal roller volume 25 of the hollow roller core 2. The air distribution chamber 17 is namely enclosed between two transverse intermediate flanges 27, 27′. The first intermediate flange 27 is mainly disc-shaped, the second intermediate flange 27′ is mainly annular. For the conduction of compressed air, the roller core 2 provides an internal air hose 16. The air hose 16 runs parallel to the central axis 26, from the air inlet 15 to near the air distribution chamber 17. Optionally, the air hose 16 is connected to a connection channel 32 that is exhausted in an end flange 27 (see FIG. 1B). Alternatively, the air hose 16 discharges directly into the air distribution chamber 17 (not shown).

The intermediate flanges 27, 27′ are welded on the inner surface 20 of the tubular supporting wall 4 (see FIG. 1B). The intermediate flanges 27, 27′ and welded joints close the air distribution chamber 17 off in an airtight manner from further chambers 29,30 within the roller volume 25. In the case of FIG. 1B, the intermediate flanges 27, 27′ are provided closer to the narrower end 5. They are only welded from this nearest end 5. This is a production advantage, given the better accessibility from the nearest end, via the short chamber 30. As can be seen further (FIG. 1B), the first intermediate flange 27 forms a spacer 28 against which the second intermediate flange 27′ abuts. The air distribution chamber 17 extends annularly around the spacer 28, and is enclosed between both intermediate flanges 27, 27′. A centrally positioned spacer 28 will contribute less to the moment of inertia.

Finally, the air distribution chamber 17 is still annularly enclosed by the inner surface 20′ of the tubular supporting wall 4. The supporting wall 4 further has as its main function that it supports the roller sleeve 3. With such a double function (i.e. Also bounding the air distribution chamber 17) savings are made on material and design complexity. The total mass and the moment of inertia are lower.

Optionally, at least one intermediate flange 27′ provides another central opening (see FIG. 1B). The mass is further limited. Along the opening edge both intermediate flanges 27, 27′ are welded to each other, so that the air distribution chamber 17 remains sealed airtight. If both intermediate flanges 27, 27′ are provided with a central opening, a through-shaft can be used (not shown). In contrast, the roller core 2 of FIG. 1B is equipped with two separate journals.

The roller core 2 now provides two or more outward air outlets 31. These extend from the air distribution chamber 17, through the supporting wall 4. Compressed air can easily be divided annularly over these air outlets 31 via the air distribution chamber 17.

The roller core 2 shown is adapted for use in applicator rollers 1 for industrial lacquering applications. In particular, the roller core 2 is suitable for receiving an interchangeable roller sleeve 3 (not shown). In addition, the inner surface 22 of the roller sleeve 3 can be stretched around the outer surface 19 of the roller core 2 under air pressure. Fitting an interchangeable roller sleeve 3 is schematically illustrated in FIG. 3A-B.

An important feature (see, for example, in FIG. 1A-B) is that the air distribution chamber 17 occupies only a smaller, airtight sealed partial volume of the roller volume 25. When mounting/dismounting roller sleeves 3 only that partial volume will come under pressure (e.g. about 7 bar). For safety reasons, said partial volume is preferably sufficiently small so that only limited pressure energy can build up within it. Preferably, the volume of the air distribution chamber is 17 such that, when applying 7 bar air pressure, the pressure energy built up is a maximum of 200 bar·L, and more preferably a maximum of 50 bar·L. It is generally recognised in pneumatic technology that special safety measures must be taken at a maximum pressure energy of 200 bar·L or higher. On the other hand, a maximum pressure energy of 50 bar·L or lower can be considered harmless. See, for example, the European Pressure Equipment Directive (2014/68/EU).

Compressed air brought into the air distribution chamber 17, will exert a radial outward pressure on the inner surface 20′ of the supporting wall 4. An advantage of the intermediate flanges 27, 27′ is that they increase mechanical strength locally. It is therefore not necessary to reinforce the supporting wall 4 as a whole.

In the embodiment of FIG. 1B the air distribution chamber 17 forms an annular passage that passes through the different air outlets 31. The passage is preferably larger (in cross-section) than the passages of the individual air outlets 31. This ensures good air distribution.

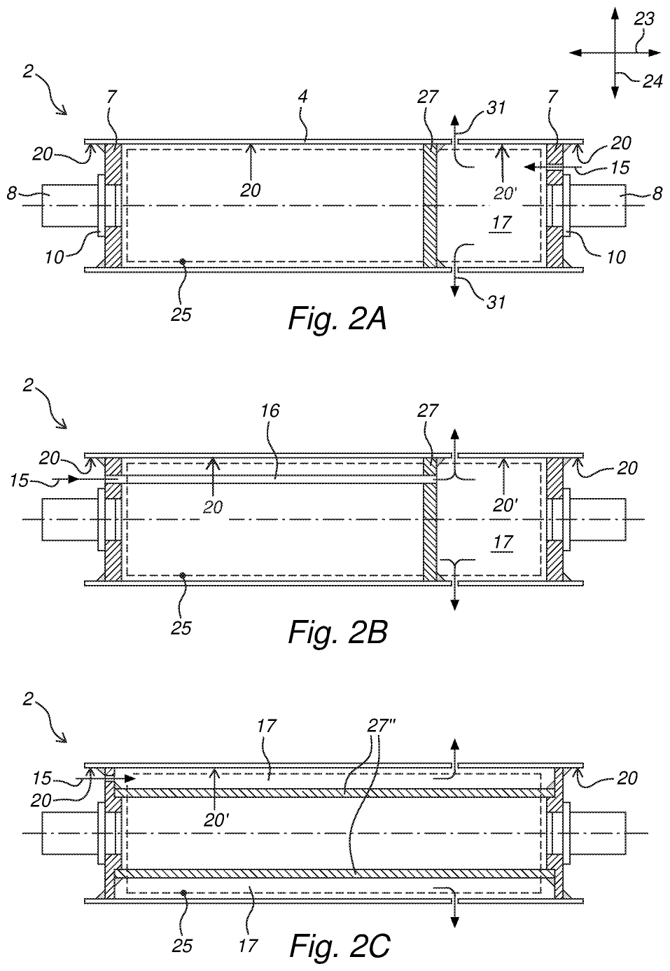

FIGS. 2A-C show roller cores 2 according to a number of alternative embodiments. The air distribution chamber 17 is always located within the internal roller volume 25. The roller core 2 also provides an internal wall portion 27, 27″ that limits the air distribution chamber 17 to a smaller, airtight sealed partial volume of the roller volume 25. The air distribution chamber 17 is further enclosed at least at the level of the air outlets 31 by the supporting wall 4. The air distribution chamber 17 thus joins the air outlets 31.

In FIG. 2A-B, the air distribution chamber 17 is mainly cylindrical, the roller core 2 comprising a disc-shaped, transverse intermediate flange 27. The roller volume 25 is therefore divided into a long chamber 29 (left) and a short air distribution chamber 17, 30 (right). Both are cylindrical. In FIG. 2A, the air intake 15 is provided as an opening through the rightmost end flange 7. The air inlet 15 leads directly into the adjacent air distribution chamber 17. In FIG. 2B, the air inlet 15 is provided on the left end flange 7, wherein compressed air is led via an air hose 16 through the long chamber 29 into the air distribution chamber 17. In both cases the air inlet 15 is positioned non-centrally. However, the invention also applies to roller cores 2 with a central air inlet 15, for example, through one of the journals 8.

It is important that compressed air within the air distribution chamber 17 will exert an outward pressure on the supporting wall 4. It is therefore advantageous that the roller core 2 is locally reinforced there, by means of the transverse intermediate flange 27. This allows the supporting wall 4 to be carried out with a smaller wall thickness. The weight and particularly the moment of inertia of the roller core 4 around the central axis 26 are therefore lower.

In FIG. 2C, the air distribution chamber 17 is mainly annular, wherein the roller core 2 comprises a tubular inner wall 27″ extending between the end flanges 7. A tubular inner wall 27″ such as this will also strengthen the roller core 2 and thereby partially relieve the supporting wall 4. The supporting wall 4 can thus be carried out with a smaller wall thickness. Considering the tubular inner wall 27″ is positioned closer to the central axis, it contributes only to a lesser extent to the moment of inertia of the roller core 2.

Another advantage of the embodiments according to FIG. 2A-C, is that the internal wall portions 27, 27″ (the transverse intermediate flange 27 and the tubular inner wall 27″) are continuously rotationally symmetrical. This is important because it concerns relatively heavy parts. The effects of a connection channel 32 (FIG. 1A-B), or internal tubing 16 can be easily offset, using just one balancing weight. At the same time, this contrasts with the internal block of NL 7 707 402, which is only periodically rotationally symmetrical. This can be a source of vibrations.

FIGS. 3A-B schematically illustrate the mounting of a loose roller sleeve 3 over a roller core 2, according to a possible embodiment. First, the roller sleeve 3 in a relaxed state is slid over the roller core 2, from the narrower end 5. See FIG. 3A. The air outlets are therein 31 covered. The annular air distribution chamber 17 is then put under air pressure. For this purpose, compressed air is introduced via the air inlet 15. Only the partial volume occupied by the air distribution chamber 17 and the air hose 16 will come under pressure therein. Given this relatively small volume, the maximum pressure energy always remains below 250 bar·L. This is advantageous with regard to safety. Compressed air now escapes through the air outlets 31, causing the roller sleeve 3 to expand radially. The expanded roller sleeve 3 can then be completely slid over the roller core 2. When the air pressure is then lowered again, the roller sleeve 3 shrinks back and fixes tightly on the roller core 2. See FIG. 3B. The roller sleeve 3 can only be removed when the air pressure is increased again.

FIGS. 4A-D finally, schematically show the manufacture of a roller core 2 according to a possible embodiment of the invention. A tubular supporting wall 4 is assumed with two open ends 5, 6. For example, this concerns a welded or centrifugally cast aluminium pipe section. Via internal wall portions 27, 27′ a smaller air distribution chamber 17 is demarcated therewithin. In the embodiment shown this concerns a first, disc-shaped intermediate flange 27 and a second annular intermediate flange 27′.

In a first step, the first intermediate flange 27 is connected to an air hose 16, at a connection channel 32 that is provided in the intermediate flange 27. The whole is then led into the supporting wall 4. The positioning (see FIG. 4B) of the intermediate flange 27 is such that it is located closer to one of the ends 5, 6. The intermediate flange 27 is then welded to the supporting wall 4, via an annular weld. The intermediate flange 27 is welded only single-sidedly, only from the nearest end 5.

Furthermore, the first intermediate flange 27 provides a spacer 28 (see also the embodiment of FIG. 1B) against which the second intermediate flange 27′ is then placed. This intermediate flange 27′ is also only connected to the supporting wall via a single-sided weld 4, only from the nearest end 5. As shown in FIG. 4B-D, the second intermediate flange 27′ forms a central opening; a single-sided weld is also provided therein. This creates an air distribution chamber 17 which is sealed airtight from a further, long chamber 29 and a further, short chamber 30 inside supporting wall 4.

Between the above-mentioned steps, or afterwards, the two end flanges 7, 7′ and the air outlets 31 can also be added. The outer surface 19 of the supporting wall 4 must be very precisely formed. Preferably, that outer surface 19 is therefore only finalised in a last step. Optionally, the roller core 2 is still balanced.

The numbered elements in the figures are:
1. Applicator roller
2. Roller core
3. Roller sleeve
4. Supporting wall
5. Narrower end
6. Wider end
7. End flange
8. Shaft or journal
9. Shaft hole
10. Shaft flange
11. Fixing hole
12. Smaller diameter
13. Larger diameter
14. Roll length
15. Air inlet
16. Air hose/tubing
17. Air distribution chamber
18. Final volume
19. Outer surface supporting wall
20. Inner surface supporting wall
21. Outer surface roller sleeve
22. Inner surface roller sleeve
23. Axial direction
24. Radial direction
25. Roller volume
26. Central axis
27. Internal wall portion
28. Spacer
29. Long chamber
30. Short chamber
31. Air outlet
32. Connection channel

It is believed that the present invention is not limited to the embodiments described above and that some modifications or changes can be added to the examples and figures described without re-evaluating the appended claims.

1. A roller core comprising a tubular supporting wall with an outer surface extending conically widening, from a narrower end to a wider end, which roller core is provided at both ends with a transverse end flange for bearing mounting via a shaft or journal, which roller core further provides an air inlet adapted for supplying compressed air to an internal air distribution chamber communicating with two or more outward air outlets through the supporting wall, and which roller core is thereby adapted to receive an interchangeable roller sleeve that can be stretched under air pressure around the supporting wall,
the air distribution chamber being located within an internal roller volume extending within the supporting wall and between the end flanges, and
the air distribution chamber being bounded annularly by the supporting wall at least at the level of the air outlets,
characterised in that the roller core comprises at least one internal wall portion, which wall portion is positioned in the roller volume, and which wall portion further limits the air distribution chamber to a smaller, airtight sealed partial volume of the roller volume.

2. The roller core according to claim 1, wherein the air distribution chamber is annular or cylindrical.

3. The roller core according to claim 1, wherein the air distribution chamber is limited to a partial volume in which at a pressure of 7 bar only a pressure energy of at most 200 bar·L can develop, preferably at most 50 bar·L.

4. The roller core according to claim 1, wherein the wall portion comprises an annular or disc-shaped, transverse intermediate flange.

5. The roller core according to claim 4, wherein the air distribution chamber is enclosed between two transverse intermediate flanges.

6. The roller core according to claim 5, wherein at least one of the intermediate flanges comprises a spacer.

7. The roller core according to claim 6, wherein the spacer is provided centrally, and wherein the air distribution chamber extends annularly around the spacer.

8. The roller core according to claim 5, wherein the intermediate flanges are integrally formed or integrally connected, preferably with a spacer between them.

9. The roller core according to claim 4, wherein said intermediate flange or intermediate flanges are welded to the supporting wall.

10. The roller core according to claim 9, wherein said intermediate flange or intermediate flanges are welded only single-sidedly, from a nearest end of the roller core.

11. The roller core according to claim 1, further provided with internal tubing for conducting compressed air from the air inlet to the air distribution chamber.

12. An applicator roller comprising a roller core and a roller sleeve, characterised in that the roller core is according to claim 1.

13. A method for mounting a roller sleeve over a conical roller core and/or for dismounting a roller sleeve from a conical roller core, wherein the roller core is according to claim 1, the method comprising the steps of: (i) introducing compressed air, from the air inlet to the air distribution chamber, and (ii) sliding the roller sleeve over the roller core, under air pressure from air outlets.

14. The method according to claim 13, wherein a pressure energy of at most 200 bar·L, preferably at most 50 bar·L, develops in the air distribution chamber.

15. A method for manufacturing a roller core according to claim 1, the method comprising welding the internal wall portion to the supporting wall and/or to at least one of the two end flanges.
